(19) United States
(12) Patent Application Publication
(10) Pub. No.: US 2015/0056050 A1
(43) Pub. Date: Feb. 26, 2015

(54) WHEELCHAIR

(71) Applicant: Julian Alex Decuir, JR., Pinon Hills, CA (US)

(72) Inventor: Julian Alex Decuir, JR., Pinon Hills, CA (US)

(21) Appl. No.: 14/463,460

(22) Filed: Aug. 19, 2014

Related U.S. Application Data
(60) Provisional application No. 61/884,310, filed on Sep. 30, 2013.
(60) Provisional application No. 61/868,007, filed on Aug. 20, 2013.

(51) Int. Cl. A61G 5/14; A61G 5/10

(52) U.S. Cl. CPC A61G 5/14; A61G 5/10
USPC 414/550

(57) ABSTRACT

A wheelchair lift mountable to a wheelchair for assisting a person in transferring him or herself on or off a wheelchair is disclosed. The wheelchair lift is attachable to a frame of the wheelchair for supporting a support over a seat of the wheelchair. The wheelchair lift is operative to raise and lower the support and also shift the support left and right to transfer the person on and off the wheelchair.

### CROSS-REFERENCE TO RELATED APPLICATIONS

This application claims the benefit of U.S. Prov. Pat. App. Ser. No. 61/868,007, filed on Aug. 20, 2013 and U.S. Prov. Pat. App. Ser. No. 61/884,310 filed on Sep. 30, 2013, the entire contents of which are expressly incorporated herein by reference.

### STATEMENT RE: FEDERALLY SPONSORED RESEARCH/DEVELOPMENT

Not Applicable

### BACKGROUND

The present invention relates to a lift for transferring a person from or to a wheelchair.

Wheelchairs assist disabled, elderly and those that are generally unable to walk to be more mobile. Unfortunately, even with a wheelchair, the person using the wheelchair may need further assistance in transferring him or herself to and from a wheelchair. For example, the person may need further assistance in using the restroom or sleeping on a bed. To this end, many individuals who utilize a wheelchair may have an assistant or relative to help them with everyday tasks such as using the restroom or resting on a bed.

Accordingly, there is a need in the art for a method and system for helping a person on and off the wheelchair.

### BRIEF SUMMARY

A wheelchair lift is disclosed herein that can be operated by the person utilizing the wheelchair. The wheelchair lift is operative to assist the person in transferring him or herself on or off the wheelchair. The wheelchair lift may be mountable to the backside or front side of the wheelchair and may have a support that can be raised or lowered as well as shifted left or right so that the person may be transferred to or from the wheelchair and onto a different support surface (e.g., toilet, bed). The wheelchair lift may have a first extension that is securable to a frame of the wheelchair and extends vertically upward. The first extension is rotatable clockwise or counterclockwise to shift the support of the wheelchair lift left or right. Moreover, the lift may also have a second extension connected to the first extension with an elbow to mitigate tip over of the wheelchair during use. The second extension has a distal end portion that is disposable over a seat of the wheelchair and may be traversed to an offset position left or right by way of rotation of the first extension. The support of the wheelchair lift may be raised and lowered by way of a strap routed on the second extension.

More particularly, a wheelchair lift for helping a rider on and off of the wheel chair is disclosed. The lift may comprise a first extension, a second extension, a support, a first motor and a second motor. The first extension may be attached to a frame of the wheel chair. The first extension may be oriented vertically when the lift is mounted to the wheelchair. The second extension may be attached to an upper distal end portion of the first extension and oriented so that a distal end portion of the second extension is disposed over a seat of the wheel chair when the lift is mounted to the wheelchair. The strap may be secured to the distal end portion of the second extension and be traversable between a lowered position and a raised position. The support may be secured to the strap so that the rider can sit on the support. The first motor may be secured to the first extension for rotating the first extension so that the distal end portion of the second extension is selectively disposable over or offset from the seat of the wheelchair. The second motor may be operative to raise or lower the support.

The first and second extensions may be connected with an elbow. The elbow may have a horizontal bar attached to the upper distal end portion of the first extension. The horizontal bar may extend away from the seat of the wheelchair. The distal end portion of the horizontal bar may be attached to a proximal end portion of the second extension.

The wheelchair lift of the wheel chair may be mounted behind the chair of the wheelchair. If so, the first extension is attached to a rear half of the frame of the wheel chair. Also, the horizontal bar then extends rearward. Alternatively or additionally, the user may have the option of mounting the wheelchair lift in front of the chair of the wheelchair. If so, the first extension is attached to a front half of the frame of the wheel chair. Also, the horizontal bar then extends forward.

The wheel chair may have wheels that are fabricated from a heavy metal. A block of heavy metal may be attached adjacent to a base of the first extension.

The wheel chair lift may also have a controller for controlling the first and second motors. Additionally, it is contemplated that a wireless device (e.g., smart phone) may include a widget for sending signals to the controllers or directly to the motors for controlling the motors.

The second extension may be pivoted with respect to the first extension. A third motor may be mounted to the wheel chair lift for pivoting the second extension.

The first and second extensions may be fabricated from a lightweight metal such as aluminum.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a wheelchair and wheelchair lift;

FIG. 2 is a side view of the wheelchair and wheelchair lift shown in FIG. 1;

FIG. 3 is a top view of a first extension and collet of the wheelchair lift;

FIG. 4 is a perspective view of a rear portion of the wheelchair having weights for mitigating tip over during use of the wheelchair lift; and

FIG. 5 is an enlarged side view of the first extension and a second extension connected to each other with an elbow for mitigating tip over during use.

### DETAILED DESCRIPTION

Referring now to the drawings, a wheelchair lift 10 is disclosed which may assist a person 12 with transporting himself or herself from a seat 14 of the wheelchair 16 to another support surface (e.g., automobile seat, dining chair, toilet, etc.). Conversely, the wheelchair lift 10 may facilitate transfer of the person 12 from the support surface to the seat 14 of the wheelchair 16. The wheelchair 16 does not tip over even though the person 12 is transferred away from the center of gravity of the wheelchair 16 due to the elbow 18 of the wheelchair lift 10 which redirects the weight force of the person 12 and also strategic positioning of weights on the wheelchair 16.

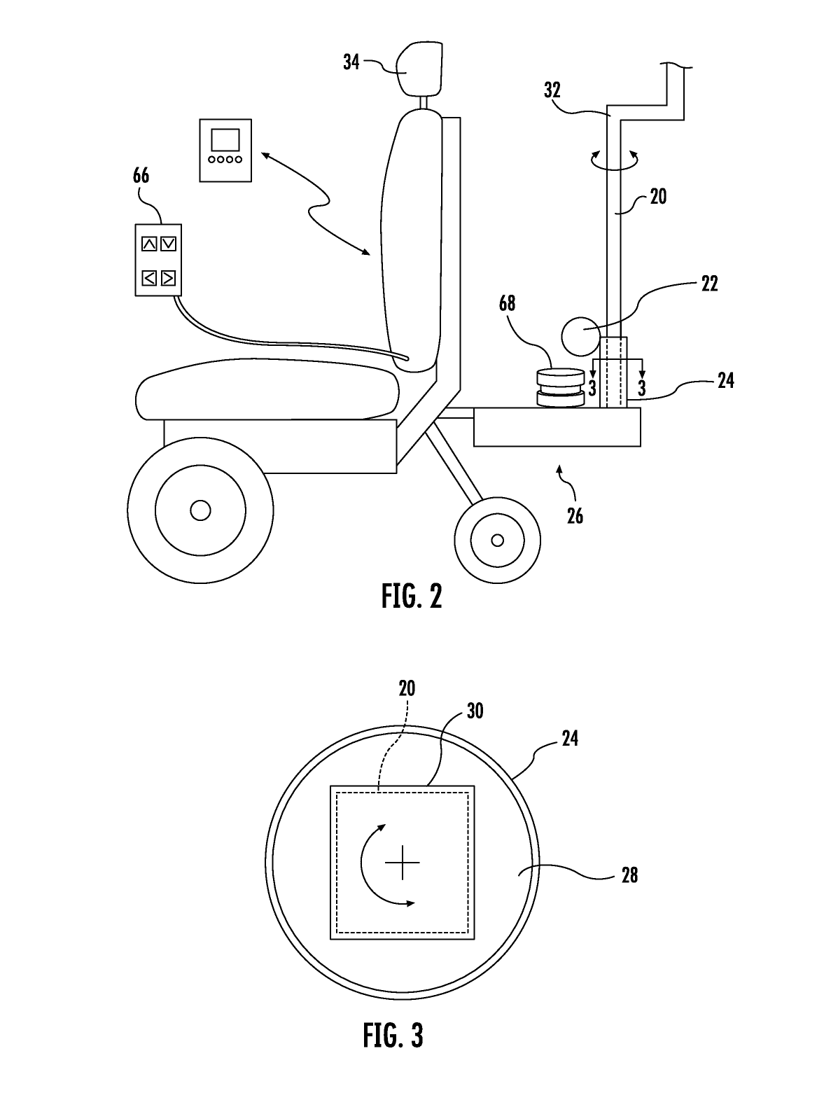

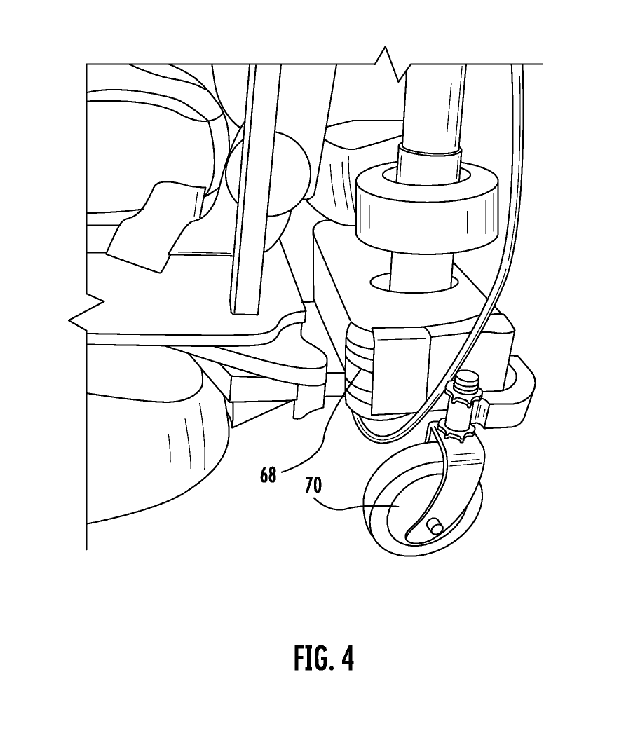

The wheelchair lift 10 may have a first extension 20 that is rotatably controllable with a rotational motor 22. In particular, a sleeve 24 may extend from a rear portion 26 of a frame of the wheelchair 16 as shown in FIGS. 2 and 3. The sleeve 24 is oriented vertically so that the first extension 20, when disposed within the sleeve 24, is oriented vertically upward. The sleeve 24 may have a collet 28 that is engaged to the motor 22. The collet 28, under power of the rotational motor 22, may rotate clockwise or counterclockwise in order to rotate the first extension 20 in the clockwise or counterclockwise direction as well. The collet 28 may have an aperture 30 in which the first extension 20 may be inserted. The first extension 20 may have a corresponding configuration compared to the aperture 30 of the collet 28 so that upon rotation of the collet 28, the first extension 20 also rotates. In the example provided in FIG. 3, the aperture 30 has a square configuration, and likewise, the first extension 20 has a corresponding square configuration.

The first extension 20 is shown as having an exterior rectangular configuration and the aperture 30 of the collet 28 as having a corresponding rectangular configuration. However, it is also contemplated that the exterior configuration of the first extension 20 and the aperture 30 of the collet 28 may have other corresponding configurations such as star shaped, polygonal shaped or round shaped. Additionally or alternatively, the first extension 20 may have a nub and the aperture 30 may have a notch for receiving the nub. The first extension 20 may project upward with its upper distal end 32 disposed at or above the head rest 34 of the wheelchair 16.

The motor 22 and the collet 28 may be engaged to each other with a belt drive, chain drive, transmission and other power transmission systems known in the art or developed in the future.

A second extension 36 extends from the first extension 20 and is sufficiently long so that a distal end portion 38 thereof 36 may be disposable over the seat 14 of the wheelchair 16. The second extension 36 may extend out from the first extension 20 at an angle 40 of about 30° from a horizontal plane. Other angles 40 are also contemplated between 10° and 65° but preferably, the angle 40 is between about 15° and 45°.

Referring now to FIG. 5, the second extension 36 may be secured to the first extension 20 by way of the elbow 18. The elbow 18 redirects the weight force of the person 12 transferred through strap 42 to mitigate tip over of the wheelchair 16 when the wheelchair lift 10 raises the person 12 out of the seat 14 of the wheelchair 16 and onto a different support surface away from the center of gravity of the wheelchair 16. The elbow 18 has a rearwardly directed arm 44 and a vertically oriented arm 46. The second extension 36 extends from the upper distal end of the vertical arm 46. The second extension 36 is rotatably connected to the vertical arm 46 at pivot point 48. The second extension 36 pivots freely about the pivot point 48 with respect to the vertical arm 46. The angle 40 of the second extension 36 to the horizontal plane may be adjusted with the telescoping rod 50. The opposed distal ends of the telescoping rod 50 are pivotable with respect to the attachment points to the second extension 36 and bracket 52 which connects the lower distal end of the telescoping rod 50. To adjust the angle 40 of the second extension 36, the length of the telescoping rod 50 is adjusted.

The strap 42 may be routed out of the second extension 36. In particular, the strap 42 may be engaged to motor 54. The strap 42 is fed through the second extension 36 and routed over roller 56. The distal end of the strap 42 may be secured to portable seat 58. The portable seat 58 may be raised and lowered by retracting or extending the strap 42 by way of motor 54. Upon retracting the strap 42, the portable seat 58 is raised. Upon extending the strap 42, the portable seat 58 is lowered.

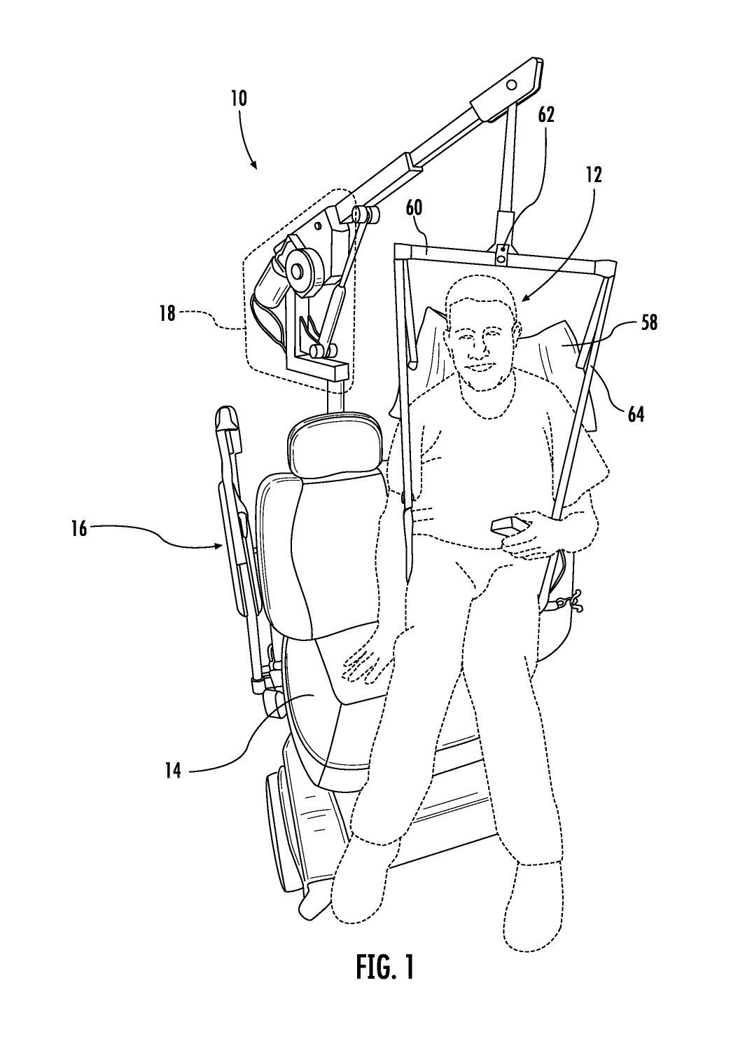

Referring back to FIG. 1, the portable seat 58 may be engaged to the distal end of the strap 42 with the transverse bar 60. The distal end of the strap 42 may have a clip 62 that engages the middle of the transverse bar 60. Additional straps 64 may extend from opposed ends of the transverse bar 60 and be engaged to the portable seat 58. The person 12 riding the wheelchair 16 sits on the portable seat 58 when being transferred to the wheelchair 16 or to a support surface away from the wheelchair 16.

The wheelchair lift 10 may also have a remote control 66 which controls the motors 22 and 54. The motor 22 rotates the first extension 20. The motor 54 extends and retracts the strap 42 to lower and raise the portable seat 58. The remote control 66 may have one or more buttons for controlling the counterclockwise or clockwise movement of the first extension 20. The remote control 66 may have another set of one or more buttons for controlling the retraction and extension of the strap 42.

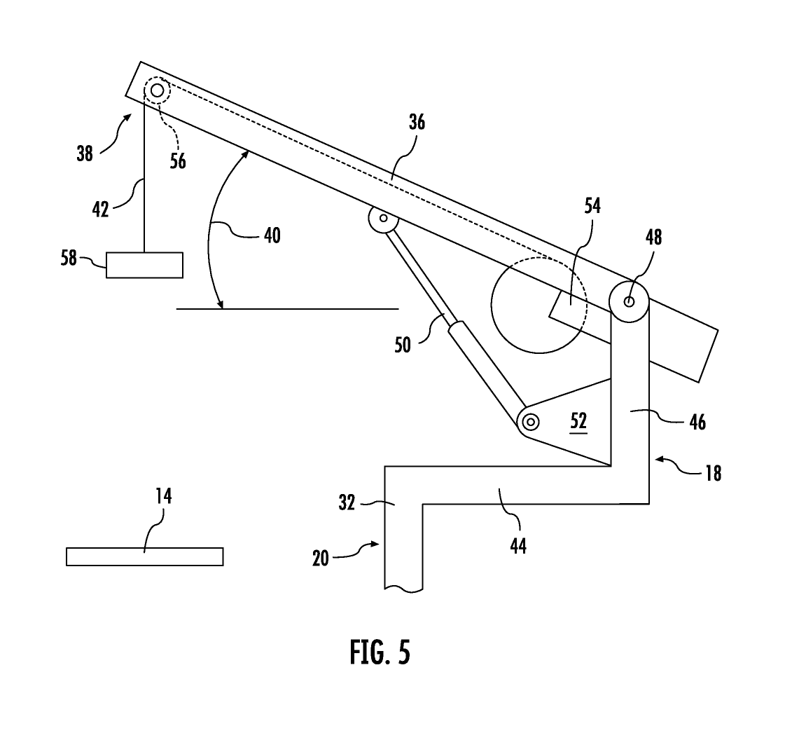

The wheelchair 16 may also have additional weights 68 (see FIGS. 2 and 4) to counterbalance the weight of the person 12 when transferring the person 12 from the wheelchair 16 to a separate support surface away from the wheelchair 16, and vice versa. Referring now to FIG. 4, weights 68 may be added to the rear portion of the wheelchair 16 adjacent to a base of the first extension 20, and more particularly adjacent to the sleeve 24 mounted to the frame of the wheelchair 16. Additionally, the wheels 70 may be formed with a heavy metal (e.g., steel) rim which is coated with a rubberized exterior for friction and comfort to the rider. The heavy metal of the rim adds additional weight to further mitigate tip over when transporting the person 12 away from or to the wheelchair 16. At least one or more of the wheels 70 and preferably all four wheels 70 of the wheelchair 16 are fabricated from a heavy metal rim with rubberized coating. Additional weights 68 may be disposed under the frame to further mitigate tip over when transporting the person 12 to and away from the wheelchair 60.

The various components of the wheelchair lift 10 may be fabricated from a lightweight material such as aluminum. In particular, the first and second extensions 20, 36 as well as the elbow 18 may be fabricated from aluminum. It is also contemplated that the first extension 20, second extension 36 and the elbow 18 may be disassembled so that these components may fit within a case so that the person 12 may transport the wheelchair lift 10 from one place to another. Upon use, the user may assemble and mount the wheelchair lift 10 on the wheelchair 16 to assist in transporting the person 12 to or away from the wheelchair 16.

Once the wheelchair lift 10 is set up on the wheelchair 16, the portable seat 58 is positioned under the person 12 on the wheelchair 16. Next, the transverse bar 60 is connected to the distal end of the strap 42 and the strap 42 is slowly retracted to lift the person 12 off of the seat 14 of the wheelchair 16. The strap 42 is retracted by actuating the motor 54 with the remote control 66. Once the person 12 is raised off of the seat 14 of the wheelchair 16, the motor 22 is actuated either to rotate the first extension 20 in the clockwise or counterclockwise direction. As the first extension 20 is rotated, the person 12 is moved away from the seat 14 of the wheelchair 16 and towards another surface such as an automobile seat, bed, bathroom toilet, or other support surface. By moving the person 12 away from the seat 14 of the wheelchair 16, the center of gravity is shifted from the center of the four wheels 70 supporting the wheelchair 16. However, the configuration of the elbow 18 assists in maintaining the wheelchair 16 and the person 12 in a stable position. Additionally, the additional weights 68 help in maintaining the balance of the wheelchair 16 and the person 12. Once the person 12 is over the support surface, the strap 42 is extended by actuating the motor 54 with the remote control 66 until the person 12 contacts and rests upon the support surface. Thereafter, the portable seat 58 is removed from underneath the person 12. The process is performed in reverse when the person 12 is transported from the support surface to the seat 14 of the wheelchair 16.

In the drawings and the description, the wheel chair lift 10 has been described as being mounted to the frame of the wheel chair behind the chair or seat of the wheel chair so that the wheel chair lift 10 raises the person 12 from behind. However, it is also contemplated that the wheel chair lift 10 may be mountable to the frame in front of the chair or seat of the wheel chair 16 and also the left or right sides thereof.

The above description is given by way of example, and not limitation. Given the above disclosure, one skilled in the art could devise variations that are within the scope and spirit of the invention disclosed herein, including various ways of adding weights 68 to the wheelchair 16. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A wheelchair lift for helping a rider on and off of a wheelchair, the wheelchair lift comprising:
a first extension removably mountable to a frame of the wheelchair, the first extension oriented vertically;
a second extension attached to an upper distal end portion of the first extension and directed so that a distal end portion of the second extension is disposed over a seat of the wheelchair when the first extension is mounted to the frame of the wheelchair;
a strap secured to the distal end portion of the second extension and being traversable between a lowered position and a raised position;
a support secured to the strap so that the rider can sit on the support when the rider is transferred on or off of the wheelchair;
a first motor secured to the first extension for rotating the first extension so that the distal end portion of the second extension is selectively disposable over the support or offset from the support; and
a second motor operative to raise or lower the support.

2. The wheelchair lift of claim 1 wherein the first and second extensions are connected with an elbow, the elbow having a horizontal bar attached to the upper distal end portion of the first extension, the horizontal bar extending rearward away from the seat of the wheelchair when the wheelchair lift is mounted to a rear of the wheelchair, the rear distal end portion of the horizontal bar attached to a proximal end portion of the second extension.

3. The wheelchair lift of claim 1 wherein the first extension is attachable to a front half of the frame of the wheel chair.

4. The wheelchair lift of claim 1 wherein the first extension is attachable to a rear half of the frame of the wheel chair.

5. The wheelchair lift of claim 1 wherein the elbow has an offset to shift the center of gravity of the second extension.

6. The wheelchair lift of claim 1 further comprising replacement wheels for the wheelchair wherein wheels are fabricated from a heavy metal.

7. The wheelchair lift of claim 1 wherein a block of heavy metal is attachable adjacent to a base of the first extension.

8. The wheelchair lift of claim 1 further comprising a controller for operating the first and second motors.

9. The wheelchair lift of claim 1 having software loaded on the controller for receiving a signal from a smartphone to control the first and second motors via the widget of the smartphone.

10. The wheelchair lift of claim 1 wherein the second extension is pivotable to the first extension, and the chair further comprises a third motor for pivoting the second extension.

11. The wheelchair lift of claim 1 wherein the first and second extensions are fabricated from a lightweight metal.

12. The wheelchair lift of claim 11 wherein the lightweight metal is aluminum.
